(19) United States
(12) Patent Application Publication
(10) Pub. No.: US 2015/0045111 A1
(43) Pub. Date: Feb. 12, 2015

(54) GAMING SYSTEM AND METHOD FOR INFORMING A PLAYER OF THE BENEFIT OF HIGHER DENOMINATION GAME PLAY

(71) Applicant: IGT, Las Vegas, NV (US)

(72) Inventors: Dwayne R. Nelson, Las Vegas, NV (US); Mira Vanblaricom, Henderson, NV (US)

(21) Appl. No.: 13/961,505

(22) Filed: Aug. 7, 2013

(51) Int. Cl. G07F 17/32

(52) U.S. Cl. CPC G07F 17/3244
USPC 463/25

(57) ABSTRACT

Various embodiments of the present disclosure provide a gaming system and method for informing a player of the benefit of higher denomination game play by determining if a latter award would have been provided for a play of a game had the game been played at a higher denomination and, if so, indicating that the award would have been larger had the higher denomination been employed. In one embodiment, the gaming system displays an outcome of a play of a game and displays an award based on the displayed outcome. The gaming system determines, based on the displayed outcome, a missed award that would have bean determined had the game been played at a higher denomination. If the missed award is greater than the displayed award, the gaming system displays an indication that a larger award would have been won had the game been played at the higher denomination.

### COPYRIGHT NOTICE

A portion of the disclosure of this patent document contains or may contain material that is subject to copyright protection. The copyright owner has no objection to the photocopy reproduction by anyone of the patent document or the patent disclosure in exactly the form it appears in the Patent and Trademark Office patent file or records, but otherwise reserves ail copyright rights whatsoever.

### BACKGROUND

Gaming systems that provide players awards in primary or base games are wall known. These gaming systems generally require a player to place a wager to activate a play of the primary game. For many of these gaming systems, any award provided to a player for a wagered-on play of a primary game is based on the player obtaining a winning symbol or a winning symbol combination and on an amount of the wafer (e.g., the higher the amount of the wager, the higher the award). Winning symbols or winning symbol combinations that are less lively to occur typically result in larger awards being provided when they do occur.

For such known gaming systems, an amount of a wager placed on a primary game by a player may vary. For instance, a gaming system may enable a player to wager a minimum quantity of credits, such as one credit (e.g., in monetary currency, one penny, nickel, dime, quarter, or dollar; in non-monetary currency, one point, credit, coin, token, free play credit or virtual buck), up to a maximum quantity of credits, such as five credits. The gaming system may enable the player to place this wager a single time or multiple times for a single play of the primary game. For instance, a gaming system configured to operate a slot game may have one or more paylines. and the gaming system may enable a player to place a wager on each of the paylines for a single play of the slot game. Thus, it is known that a gaming system, such as one configured to operate a slot game, may enable players to place wagers of substantially different amounts on each play of a primary game. For example, the amounts of the wagers may range from one credit up to 125 credits (e.g., five credits on each of twenty-five separate paylines). This is also true for other wagering games, such as video draw poker, in which players can place wagers of one or more credits on each hand, and in which multiple hands can be played simultaneously. Accordingly, it should be appreciated that different players play at substantially different wager amounts or levels and substantially different rates of play.

Bonus or secondary games are also known in gaming systems. Such gaming systems usually provide an award to a player for a play of one such bonus game in addition to any awards provided for any plays of any primary games. Bonus games usually do not require an additional wager to be placed by the player to be initiated. Bonus games are typically initiated or triggered upon an occurrence of a designated triggering symbol or designated triggering symbol combination in the primary game. For instance, a gaming system may initiate or trigger a bonus game when a bonus symbol occurs on the payline on the third reel of a three reel slot machine. The gaming systems generally indicates when a bonus game is initiated or triggered through one or more visual and/or audio output devices, such as the reels, tights, speakers, display screens, etc. Part of the enjoyment and excitement of playing certain gaming systems is the initiation or triggering of a bonus game, even before the player knows an amount of a bonus award won via the bonus game.

For a particular game (such as a popular game), a gaming establishment (such as a casino) typically includes a plurality of different electronic gaming machines (EGMs) of different set denominations configured to operate that game scattered throughout the gaming machine floor. For instance, a gaming establishment may include four EGMs configured to operate that game at a $0.01 denomination, two EGMs configured to operate that game at a $0.25 denomination, and one EGM configured to operate that game at a $1 denomination on the gaming establishment's floor. This accommodates players having different bankrolls, different risk tolerances, and the like. If a player of the game at one of these EGMs desires to play the game at a different denomination, in this instance the player must cash out of the EGM at which tie-player is playing the game and walk to the EGM configured to operate the game at the desired denomination.

Certain known EGMs enable a player to choose the denomination at which the player desires to play a particular game on those EGMs, and to modify the denomination between plays of the game as the player sees fit. For instance, one known gaming system enables a player to choose whether to play a particular game at a $0.01 denomination, a $0.02 denomination, a $0.05 denomination, or a $0.10 denomination.

Most EGMs are designed to pay back, on average, a certain percentage of the amount of money wagered fey players over a large number of plays of the game on those EGMs. The average percentage of money wagered that is paid back to the players is typically called the average expected payback percentage, the average expected payback, or the average expected return. The mare games that are played on a given EGM, the more likely that the actual payback percentage will approach the average expected payback percentage. For a typical wagering game including a primary slot game and one or more bonus games, the average expected payback percentage provided by an EGM configured to operate that wagering game includes the average expected payback percentage of the primary slot game and the average expected payback percentage(s) of any bonus games that may be triggered. The average expected payback percentage of the primary slot game is determined by: (a) the paytable of the primary slot game, which includes the winning symbol combinations and their corresponding awards; and (b) the proportion of symbols on the reels of the primary slot game, which determines the probability that any of the winning symbol combinations will be displayed on toe reels for a play of the primary slot game. Thus, modifying the paytable of the primary slot game and/or the proportion of the symbols on the reels of the primary slot game will, in most cases, change the average expected payback percentage of the primary slot game.

For certain known primary slot games, the average expected payback percentages of the primary slot games increase as the denomination at which those primary slot games are played increases. For instance, for these known primary slot games, the average expected payback percentages of the primary slot games when played at a $1 denomination are higher than the average expected payback percentages of the primary slot games when played at a $0.01 denomination. As noted above, the average expected payback percentages of these primary slot games may be increased by, for instance: (a) increasing one or more awards associated with one of the winning symbol combinations m the paytable, (b) adding a winning symbol combination to the paytable, (c) increasing the proportion of one or more symbols inducted in winning symbol combinations on the reels, or (d) any suitable combination thereof. Thus, playing one of these primary slot games at a higher denomination is typically more beneficial to a player than playing one of these primary slot games at a comparatively lower denomination because the player reaps the benefits of the higher average expected payback percentage. Many players do not, however, understand tills or fail to take this into account when determining at which denomination to play a game or when determining whether to switch denominations.

There is, therefore, a continuing need for new and improved ways to inform players that playing a particular game at a higher denomination is typically more beneficial to the player than playing that same game at a comparatively lower denomination.

### SUMMARY

Various embodiments of the present disclosure provide a gaming system and method for informing a player of the benefit of higher denomination game play. Generally, the gaming system of the present disclosure does so by determining if a player would have won a larger award for a play of a game had the player been playing the same game at a higher denomination and, if so, displaying an indication to the player that the player's award would have been larger had the player been playing the game at the higher denomination. Put differently, the gaming system notifies the player if the player's award per monetary unit wagered for that particular play of the game would have beers larger had the player been playing the game at the higher denomination.

More specifically, if one embodiment, the gaming system receives, a wager on a play of a game at a first denomination (such as $0.01). The gaming system determines an outcome of the wagered-on play of the game at the first denomination and displays the determined outcome. The gaming system determines an award amount associated with the displayed outcome of the wagered-on play of the game at the first denomination and displays the determined award amount. The gaming system determines, based on the displayed outcome of the wagered-on play of the game at the first denomination, if the player would have won a higher award amount had the game been played at a second higher denomination (such as $1). In other words, using the same outcome determined for the wagered-on play of the game and the same monetary wager, the gaming system determines whether that outcome would have resulted in the gaming system determining a higher award amount had the game been played at the second higher denomination.

If the outcome would not have resulted in the gaming system determining a higher award amount had the game been played at the second higher denomination, the gaming system ends the play of the game. If, on the other hand, the gaming system determines that the outcome would have resulted in the gaming system determining a higher sward amount had the game been played at the second higher denomination, the gaming system displays an indication that a higher award amount would have been won had the game been played at the second higher denomination.

In another embodiment, the gaming system determines, based on the displayed outcome of the wagered-on play of the game at the first denomination and the same monetary wager. If the player would have won a higher award amount had the game been played at a second higher denomination by determining a missed award amount based on me displayed outcome of the wagered-on play of the game at the first denomination. Put differently, the gaming system uses the same outcome determined for the wagered-on play of the game and the same monetary wager to determine an award amount that would have been determined had the game been played at the second higher denomination).

In this embodiment, the gaming system determines whether the determined outcome would have resulted in the gaming system determining a higher award amount had the game been played at the second higher denomination by determining whether the missed award amount is greater than the displayed award amount associated with the displayed outcome of the wagered-on play of the game at the first denomination. If not, the gaming system ends the play of the game, it on the other hand, the gaming system determines that the missed award amount is greater than the displayed award amount associated with the displayed outcome of the wagered-on play of the game at the first denomination, the gaming system displays an indication that a higher award amount would have been won had the game bean played at the second higher denomination.

It should thus be appreciated that the gaming system and method of the present disclosure provide new ways of informing players that playing a particular game at a higher denomination is more beneficial to the player than playing that same game at a comparatively lower denomination.

Additional features and advantages are described herein, and will be apparent from, the following Detailed Description and the Figures.

### BRIEF DESCRIPTION OF THE FIGURES

FIG. 1 is a flowchart illustrating an example method of operating one embodiment of the gaming system of the present disclosure.

FIGS. 2, 3, and 4A illustrate screen shots of one example embodiment of the gaming system of the present disclosure providing a play of a slot game and displaying an indication when the player would have won a larger award had the player played the slot game at a higher denomination.

FIG. 4B illustrates a screen shot of another embodiment of the gaming system of the present disclosure in which the gaming system displays a different indication when the player would have won a larger award had the player played the slot game at a higher denomination.

FIG. 4C illustrates a screen shot of another embodiment of the gaming system of the present disclosure in which the gaming system displays another different indication when the player would have won a larger award had the player played the slot game at a higher denomination.

FIG. 4D illustrates a screen shot of another embodiment of the gaming system of the present disclosure in which the gaming system displays another different indication when the player would have won a larger award had the player played the slot game at a higher denomination.

FIG. 5 illustrates a screen shot of another embodiment of the gaming system of the present disclosure in which the gaming system displays a graphical indication of the awards the player has won playing the game and the awards the player would have won had the player played the game at a higher denomination versos time.

FIG. 6A is a schematic block diagram of one embodiment of a network configuration of the gaming system of the present disclosure.

FIG. 6B is a schematic block diagram of an example electronic configuration of the gaming system of the present disclosure.

FIGS. 7A and 7B are perspective views of example alternative embodiments of the gaming system of the present disclosure.

### DETAILED DESCRIPTION

### Informing a Player of the Benefit of Higher Denomination Game Play

Various embodiments of the present disclosure provide a gaming system and method for informing a player of the benefit of higher denomination game play. Generally, the gaming system of the present disclosure does so by determining if a player would have won a larger award for a play of a game had the player been playing the same game at a higher denomination and, if so, displaying an indication to the player that the player's award would have been larger had the player been playing the game at the higher denomination. Put differently, the gaming system notifies the player if the player's award per monetary unit wagered for that particular play of the game would have been larger had the player been playing the game at the higher denomination. While any credit balances, any wagers, and any awards are displayed as amounts of monetary currency or credits in me embodiments described below, one or more of such credit balances, such wagers, and such awards may be for non-monetary credits or currency, promotional credits, and/or player tracking points or credits,

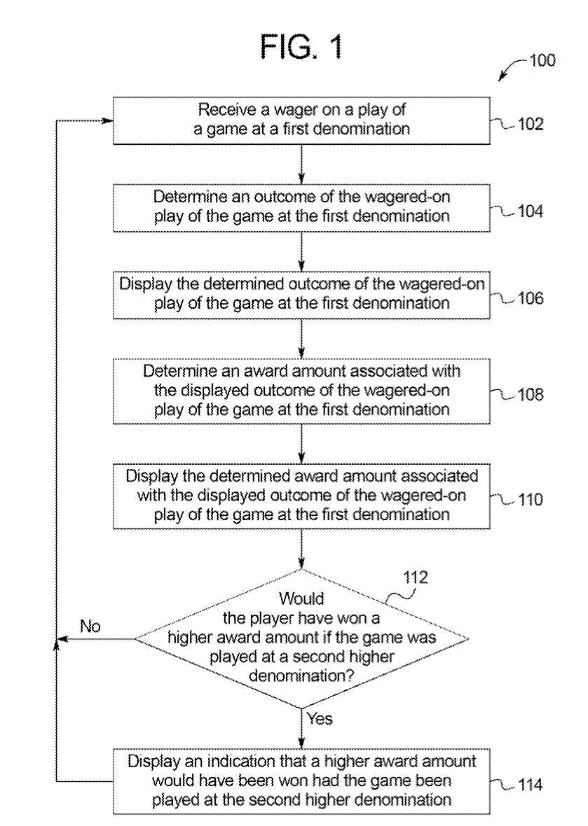

FIG. 1 illustrates a flowchart of an example process or method 100 of operating one embodiment of the gaming system of the present disclosure. In various embodiments, process 100 is represented by a set of instructions stored in one or more memories and executed by one or more processors. Although process 100 is described with reference to the flowchart shown in FIG. 1, it should be appreciated that many other processes of performing the acts associated with this illustrated process 100 may be employed. For example, the order of certain of the illustrated blocks and/or diamonds may be changed, certain of the illustrated blocks and/or diamonds may fee optional, and/or certain of the illustrated blocks and/or diamonds may not be employed.

In operation of this example embodiment, the gaming system receives a wager (such as from a player) on a play of a game at a first denomination, as indicated by block 102. The gaming system determines an outcome of the wagered-on play of the game at the first denomination, as indicated by block 104, and displays the determined outcome, as indicated by block 108. The gaming system determines an award amount associated with the displayed outcome of the wagered-on play of the game at the first denomination, as indicated by block 108, and displays the determined award amount, as indicated by block 110. The gaming system determines, based on the displayed outcome of the wagered-on play of the game at the first denomination, if the player would have won a higher award amount if the game was played at a second higher denomination, as indicated fey diamond 112. In other words, using the same outcome determined for the wagered-on play of the game and the same monetary wager, the gaming system determines whether that outcome would have resulted in the gaming system determining a higher award amount had the game been played at the second higher denomination.

If the outcome would not have resulted in the gaming system determining a higher award amount had the game been played at the second higher denomination, the gaming system ends the play of the game and process 100 returns to block 102 for another play of the game. If, on the other hand, the gaming system determines that the outcome would have resulted in the gaming system determining a higher award amount had the game been played at the second higher denomination, the gaming system displays an indication that a higher award amount would have been won had the game been played at the second higher denomination, as indicated by block 114. Put differently, if the gaming system determines that the award per monetary unit wagered by the player would have been higher had the game been played at the second higher denomination, the gaming system displays the indication that a higher award amount would have been won had the game been played at the second higher denomination.

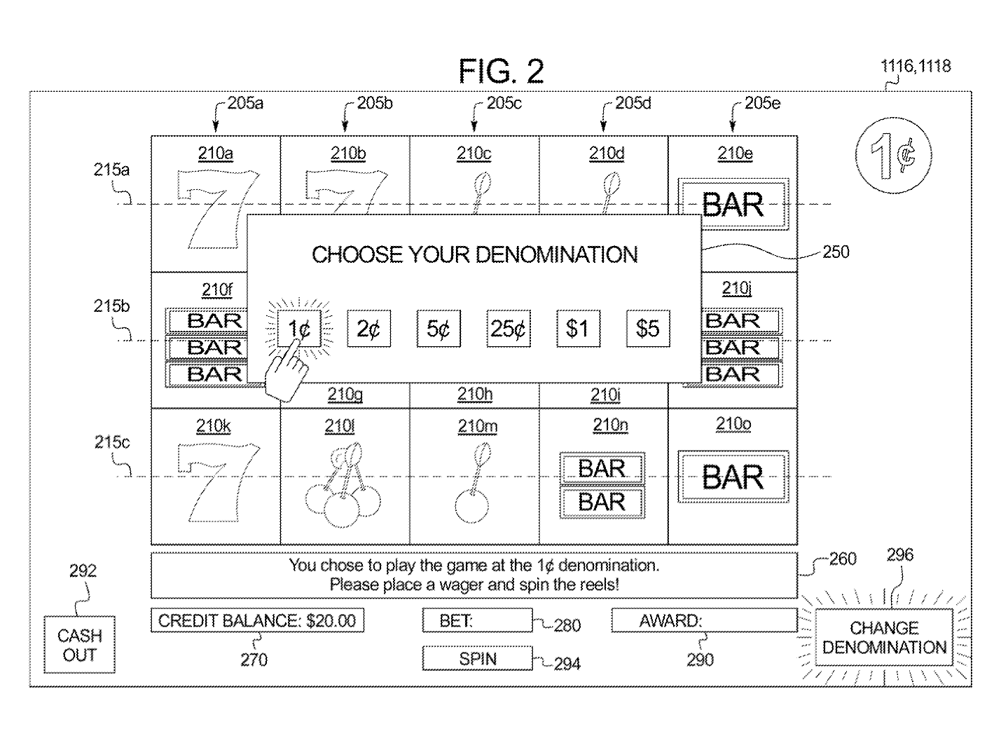

FIGS. 2, 3, and 4A illustrate screen shots of one example embodiment of the gaming system of the present disclosure providing a play of a slot game according to the process 100 described above. While the gaming system is configured to operate the slot game in this example embodiment, it should be appreciated that the gaming system may be configured to operate any suitable game (as described below).

In this example embodiment, the gaming system displays, such as on a display device 1116 or 1118 (described below), a plurality of reels 205a, 206b, 205c, 205d, and 205e, each of which is associated with a plurality of symbols. Each of the reels is associated with, and is configured to display symbols at, a different plurality of symbol display areas including symbol display areas 210a, 210b, 210c, 210d, 210e, 210f, 210g, 210h, 210i, 210j, 210k, 210l, 210m, 210n, and 210o arranged in a 3×5 grid or matrix. More specifically, in this example embodiment: (a) reel 205a is associated with, and configured to display symbols at, symbol display areas 210a, 210f, and 210k; (b) reel 205b is associated with, and configured to display symbols at symbol display areas 210b, 210g, and 210l, (c) reel 206c is associated with, and configured to display symbols at, symbol display areas 210c, 210h, and 210m; (d) reel 206d is associated with, and configured to display symbols at. symbol display areas 210d, 210l, and 210n; and (e) reel 205e is associated with, and configured to display symbols at, symbol display areas 210e, 210j, and 210o.

The gaming system displays a plurality of paylines 215a, 215b, and 215c, each of which is associated with a different plurality of the symbol display areas. In this example embodiment: (a) payline 215a is associated with symbol display areas 210a, 210b, 210c, 210d, and 210e; (b) payline 215b is associated with symbol display areas 210f, 210g, 210h, 210i, and 210j; and (c) payline 215c is associated with symbol display areas 210k, 210l, 210m. 210n, and 210o.

The gaming system also displays; (a) a message box 260 to which the gaming system displays a variety of messages or indications before, during, or after play of the slot game; (b) a plurality of meters including; (i) a credit meter 270 in which the gaming system displays the player s credit balance (in credit or currency form), (ii) a wager meter 280 that displays any wager placed on a play of the slot game (in credit or currency form), and (iii) an award meter 290 that displays any awards won during the play of the slot game (in credit or currency form); and (c) a plurality of virtual buttons that the gaming system enables the player to actuate, including: (i) a Cash Out button 292 that, when actuated by the player, causes the gaming system to provide the player with the player's credit balance (such as by pruning a ticket that is exchangeable for the monetary value of the player s credit balance), (ii) a spin button 294 that, when actuated by the player after the gaming system receives a wager, initiates a spin of the reels; and (iii) a Change Denomination button 208 that, when actuated by the player, enables the player to change the denomination at which the slot game is played. While in this illustrated example the gaming system indicates the player's credit balance, any wagers, and any awards in the form of amounts of currency, if should be appreciated that such indications may alternatively or additionally be made in the form of amounts of credits.

Turning to FIG. 2, the gaming system received value of $20.00 from a player, and established the player's credit balance of $20.00, as indicated by the credit meter 270. The gaming system received an actuation of the Change Denomination button 296 and, in response, displayed a denomination selection pop-up or dialog box 250. In this example embodiment, the gaming system enables the player to select one of six different denominations at which to play the slot game: $0.01, $0.02, $0.05, $0.25, $1, and $5.

In this example embodiment, the average expected payback percentage of the slot game increases as the denomination at which the slot game is played increases, yore specifically, in this example embodiment, the award multipliers (and, therefore, the awards for a given wager) increase for certain of the winning symbol combinations as the denomination increases. For example, with respect to a Seven-Seven-Seven-Seven-Seven winning symbol combination: (a) the award multiplier associated with the $0.01 denomination is 1000×, (b) the award multiplier associated with the $0.02 denomination is 1010×, (c) the award multiplier associated with the $0.05 denomination is 1050×, (d) the award multiplier associated with the $0,25 denomination is 1250×, (e) the award multiplier associated with the $1 denomination is 1500×, and (f) the award multiplier associated with the $5 denomination is 2000×. This, because the award for a given winning outcome and a given monetary wager increases as the denomination increases. In this example embodiment: the average expected payback percentage of the slot game played at the $5 denomination is greater than the average expected payback percentage of the slot game played at the $1 denomination, which is greater than the average expected payback percentage of the slot game played at the $0.25 denomination, which is greater than the average expected payback percentage of the slot game played at the $0.05 denomination, which is greater than the average expected payback percentage of the slot game played at the $0.02 denomination, which is greater than the average expected payback percentage of the slot game played at the $0.01 denomination.

As shown in FIG. 2, the gaming system receives a selection of the $0.01 denomination from the player and, therefore,, enables the player to play the slot game at the $0.01 denomination. The gaming system displays the following message in message box 260: “YOU CHOSE TO FLAY THE GAME AT THE 1¢ DENOMINATION. PLEASE PLACE A WAGER AMD SPIN THE REELS!”

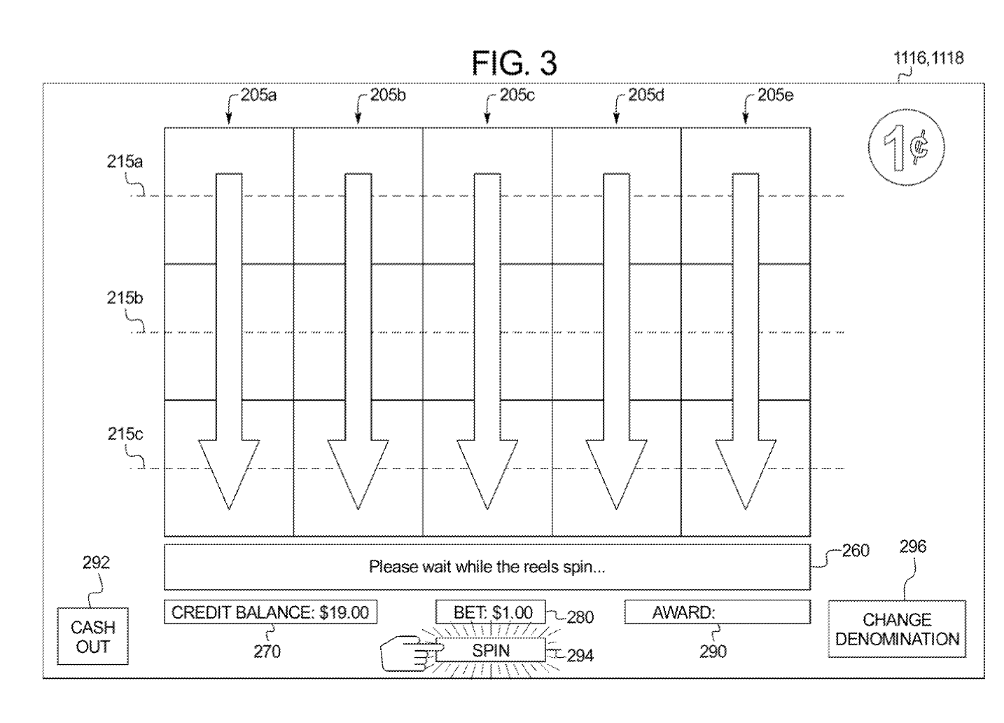

As illustrated in FIG. 3, the gaming system receives a wager of $1.00 from the player, receives an actuation of the Spin Button 294 from the player to initiate a spin of the reels, and displays each of the reels spinning. The gaming system displays the following message in message box 280: “PLEASE WAIT WHILE THE REELS SPIN . . . ”

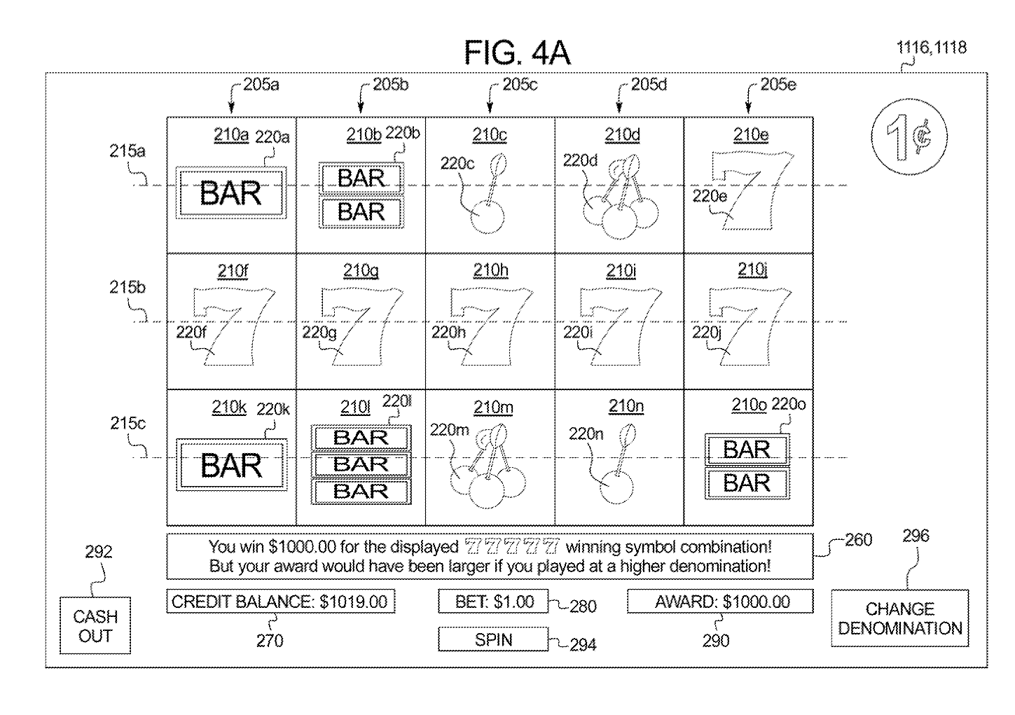

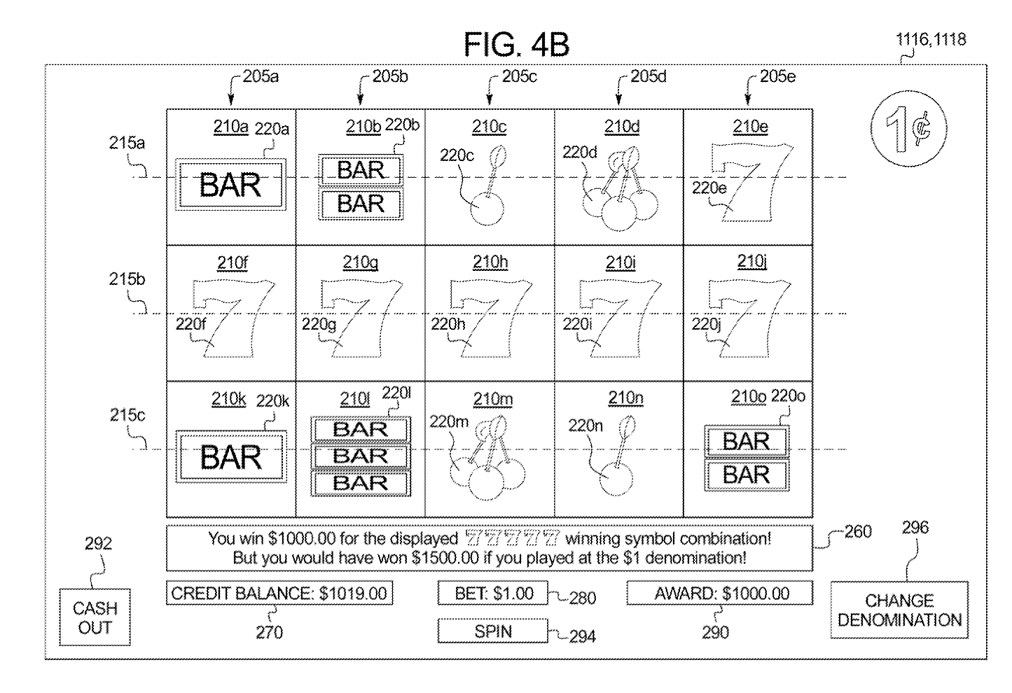

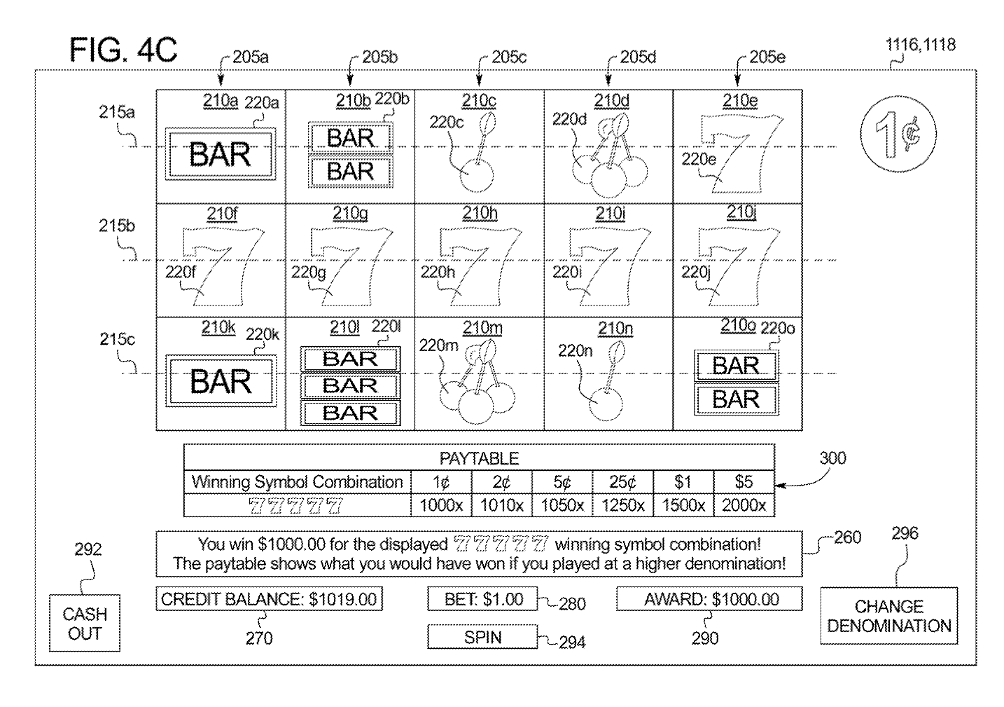

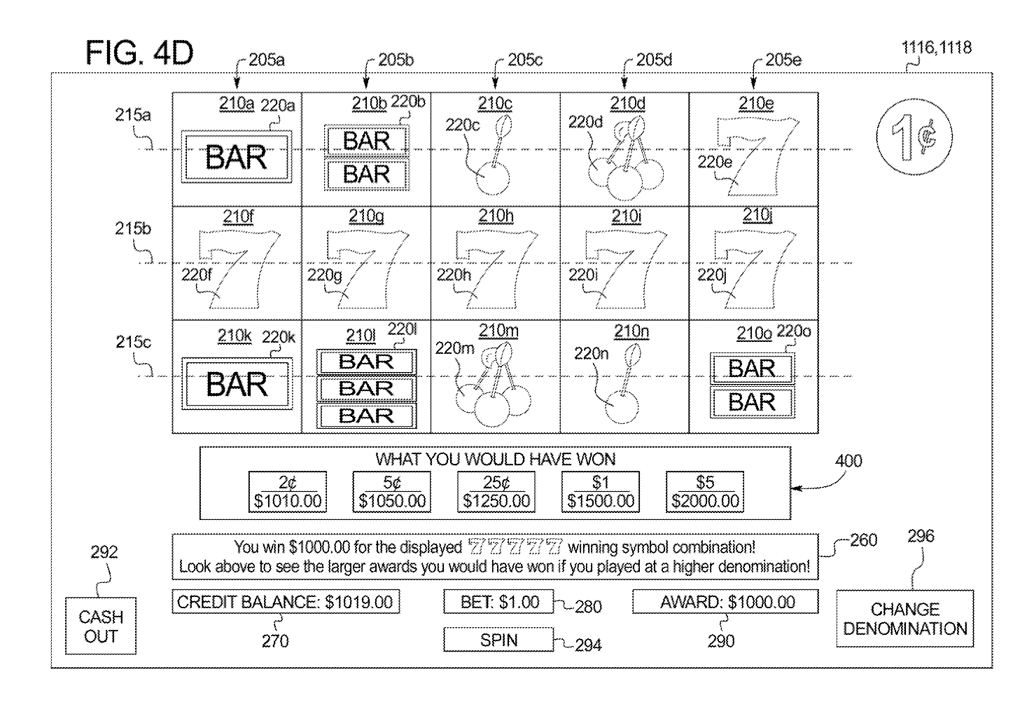

As illustrated in FIG. 4A, the gaming system stops the reels such that a plurality of the symbols associated with the reels are displayed at the symbol display areas:. In this example embodiment, the gaming system stops the reels such that: Bar symbol 220a is displayed at symbol display area 210a, Double Bar symbol 220b is displayed at symbol display area 210b, Cherry symbol 220c is displayed at symbol display area, 210c, Triple Cherry symbol 220d is displayed at symbol display area 210d, Seven symbol 220e is displayed at symbol display area 210e, Seven symbol 220l is displayed at symbol display area 2101, Seven symbol 220g is displayed at symbol display area 210g, Seven symbol 220h is displayed at symbol display area 210h, Seven symbol 220i is displayed at symbol display area 210f, Seven symbol 220j is displayed at symbol display area 210j, Bar symbol 220k is displayed at symbol display area 210k, Triple: Bar symbol 220l is displayed at symbol display area 2101, Triple Cherry symbol 220m is displayed at symbol display area 210m, Cherry symbol 220n is displayed at symbol display area 210n, and Double Bar symbol 220o is displayed at symbol display area 210o.

The gaming system makes an award determination based on the displayed symbols and a paytable associated with the $0.01 denomination (not shown). More specifically, the gaming system determines whether any of a plurality of winning symbol combinations included in the paytable are displayed along paylines 216a, 215b, and/or 215c, in this example embodiment, the gaming system determines that the Seven-Seven-Seven-Seven-Seven winning symbol combination is displayed along payline 215b, and determines an award of $1000.00 associated with the displayed Seven-Seven-Seven-Seven-Seven winning symbol combination. The gaming system updates the award meter 290; and the credit meter 270 to reflect the $1000.00 award.

In this example embodiment, the gaming system determines whether the player would have won a larger award if the game was played at a higher denomination by determining whether the player would have won a larger award if the game was played at any of the denominations higher than the denomination at which the player played the game. If the player would have won a larger award if the game was played at at least one of the higher denominations, the gaming system determines that the player would have won a larger award if the game was played at a higher denomination.

Thus, in this, example embodiment, the gaming system determines whether the player would have won a larger award if the game was played at (a) the $0.02 denomination, (b) the $0.05 denomination, (c) the $0.10 denomination, (d) the $1 denomination, or (e) the $5 denomination. To do so, in this example embodiment, the gaming system determines a missed award (if any) that would have been determined bad the game been played at each of the higher denominations. Here, the gaming system evaluates, the same displayed outcome (i.e., the symbols displayed on the reels in FIG. 4A, including the displayed Seven-Seven-Seven-Seven-Seven winning symbol combination) at the same monetary amount wagered ($1.00 in this example embodiment) according to: (a) the paytable associated with the $0.02 denomination (not shown) and determines a missed award of $1010.00: (b) the paytable associated with the $0.05 denomination (not shown) and determines a missed award of $1050.00; (c) the paytable associated with the $0.25 denomination (not shown) and determines a missed award of $1250,00; (d) the paytable associated with the $1 denomination (not shown) and determines a missed award of $1500,00; and (e) the paytable associated with the $5 denomination (not shown) and determines a missed award of $2000.00. Thus, in this example embodiment, the gaming system determines that the player would have won a larger award had the player played the slot game (i.e., placed the same monetary wager and achieved tie same outcome) at any of the $0.02 denomination, the $0.05 denomination, the $0.25 denomination, the $1 denomination, or the $5 denomination.

Since the player would have won a larger award if the game was played at at least one of the higher denominations, the gaming system displays an indication that a larger award would have been won had the player played the slot game a a higher denomination. Accordingly, the gaming system displays the following message in message box 260: “YOU WIN $1000.00 FOR THE 7 7 7 7 7 WINNING SYMBOL COMBINATION! BUT YOUR AWARD WOULD HAVE SEEN LARGER IF YOU PLAYED AT A HIGHER DENOMINATION!”

It should be appreciated that the gaming system may indicate that the player would have won a larger award had the player played the slot game at a higher denomination in any suitable manner. Various manners in which the gaming system may indicate that the player would have won a larger award had the player played the slot game at a higher denomination are described below.

In another embodiment, the gaming system indicates that the player would haw won a larger award had the player played the slot game at a higher denomination by displaying the missed award amount itself. FIG. 4B illustrates an example of one such embodiment. In FIG. 4B, the gaming system displays an indication to the player that the player would have won an award of $1100,00 (i.e., the missed award amount) had the player played the slot game at the $1 denomination instead of the $0.01 denomination. Specifically, the gaming system displays the following message in message box 260: “YOU WIN $1000.00 FOR THE DISPLAYED 7 7 7 7 7 WINNING SYMBOL COMBINATION! BUT YOU WOULD HAVE WON $1500.00 IF YOU PLAYED AT THE $1 DENOMINATION!”

In another embodiment, the gaming system indicates that the player would have won a larger award had the player played the slot game at a higher denomination by displaying the paytable (or a relevant portion thereof) associated with one or more higher denominations to the player. FIG. 4C illustrates an example of one such embodiment. In FIG. 4C, the gaming system displays: (a) an indication to the player that the player would have won a larger award had the player played the slot game at a higher denomination; and (b) a paytable portion 300 including the award multipliers for each of the denominations for the displayed Seven-Seven-Seven-Seven-Seven winning symbol combination, which enables the player to see the comparatively larger award multipliers associated with the higher denominations. Specifically, the gaming system displays the following message in message box 260: “YOU WIN $1000,00 FOR THE 7 7 7 7 7 WINNING SYMBOL COMBINATION! THE PAYTABLE SHOWS WHAT YOU WOULD HAVE WON If YOU PLAYED AT A HIGHER DENOMINATION!”

In another embodiments the gaming system indicates that the player would have won a larger award had the player played the slot game at a higher denomination by displaying a missed award amount associated with each higher denomination (or each of a subset of a plurality of higher denominations) to the player. FIG. 4D illustrates an example of one such embodiment. In FIG. 4D, the gaming system displays a missed award pop-up or dialog box 400 that indicates that the player would have won: (a) an award of $1010.00 (i.e., the missed award amount) had the player played the slot game at the $0.02 denomination; (b) an award of $1050.00 (i.e., the missed award amount) had the player played the slot game at the $0.06 denomination; (c) an award of $1250,00 (i.e., the missed award amount) had the player played the slot game at the $0.25 denomination; (d) an award of $1500.00 (i.e., the missed award amount) had the player played the slot game at the $1 denomination; and (a) an award of $2000.00 (i.e., the missed award amount) had the player played the slot game at the $5 denomination. Specifically, the gaming system displays the following message in message box 260; “YOU WIN $1000,00 FOR THE DISPLAYED 7 7 7 7 7 WINNING SYMBOL COMBINATION! LOOK ABOVE TO SEE THE LARGER AWARDS YOU WOULD HAVE WON IF YOU PLAYED AT A HIGHER DENOMINATION!” it should be appreciated that the gaming system may display any suitable subset of the missed awards.

In various embodiments, the gaming system indicates that the player would have won a larger award had the player played the slot game at a higher denomination by displaying a plurality of total award meters. One of the total award meters includes a sum of any awards won by the player over a designated period (such as a designated period of time (e.g., the past 30 minutes or the past hour), a period of time associated with a certain amount wagered (e.g., the period of time associated with the previous $20.00 wagered); a period of time since a last deposit was made (e.g., the period of time since the player last inserted currency into the gaming system), a period of time since a player tracking card was inserted info the gaming system; a period of time since initiation of the player's gaming session; such as a designated quantity of plays (e.g., the past 30 plays or the past 100 plays); a quantity of plays associated with a certain amount wagered (e.g., the quantity of plays associated with the previous $20.00 wagered); a quantity of plays since a last deposit was made (e.g., the quantity of plays since the player last inserted currency into the gaming system); a quantity of plays Since a player tracking card was inserted into the gaming system; and a quantity of plays since initiation of the player's gaming session). At least one other total award meter includes a sum of any missed awards that would have been won by the player over the designated period had the player been playing the slot game at a particular higher denomination. For example, the gaming system displays a separate total award meter associated with each higher denomination to show the player the awards the player would have won doting the designated period had the player been playing at any of those higher denominations.

In certain such embodiments, the gaming system displays and updates the total award meters m real-time. In other words, in these embodiments, the gaming system updates the total award meters after each play of the slot game. In other such embodiments, the gaming system displays and updates the total award meters upon the occurrence of a triggering event in one example embodiment, the triggering event occurs when the player's credit balance reaches a designated amount, such as zero. In another example embodiment, the triggering event occurs when the gaming system receives an actuation of the Cash Out button from the player.

In various embodiments, rather than or in addition to displaying the missed award that would have been won had the player been playing the slot game at a higher denomination, the gaming system determines and displays how much more the player would have won had the player been playing the slot game at the higher denomination. For instance, if the player won %1000.00 playing the slot game at the $0.01 denomination and would have won $1500.00 had the player been playing the slot game at the $1 denomination, the gaming system displays an indication that the player would have won an extra $500.00 had the player been playing the slot game at the $1 denomination.

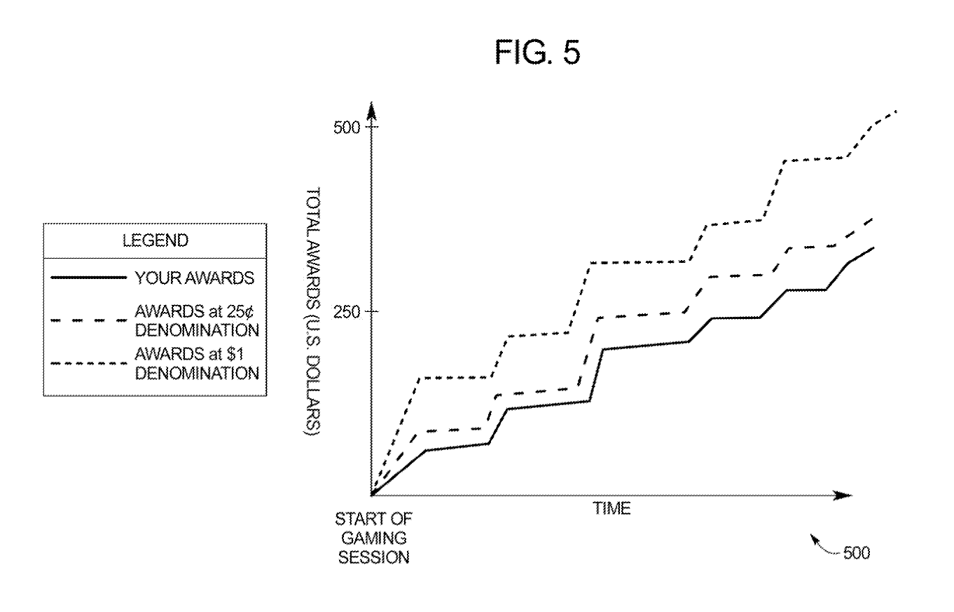

In other embodiments, rather than (or in addition to) displaying one or more total award meters, the gaming system displays similar information in graphical form, such as in the form of a line graph and/or a bar graph. FIG. 5 illustrates one example embodiment in which the gaming system displays a line graph 500 plotting the awards won by the player and the missed awards that would have been won had the player been playing the slot game at the $0.26 denomination or the $1 denomination versus time. It should be appreciated that the graph 500 may be displayed in any suitable manner, such as on a display device of a top box of the gaming system, a player tracking display, a separate service window, or on the same display screen on which the gaming system displays the slot game.

In another embodiment, the gaming system indicates that the player would have won a larger award had the player played the slot game at a higher denomination by printing any of the information described above on the ticket printed by the gaming system when the gaming system receives an actuation of the Cash Out button from the player.

In another embodiment, the gaming system indicates that the player would have won a larger award had the player played the slot game at a higher denomination by displaying the average expected payback percentage of the slot game during a designated period (such as any of those listed above) as well as what the average expected payback percentage of the game would have been had the player been playing the slot game at one or more higher denominations. For instance, the gaming system could display the following “OVER THE PAST HOUR YOUR AVERAGE EXPECTED PAYBACK PERCENTAGE WAS 85% HAD YOU PLAYED AT THE $1 DENOMINATION YOUR AVERAGE EXPECTED PAYBACK PERCENTAGE WOULD HAVE BEEN 92%!”

In another embodiment, the gaming system indicates that the player would have won a larger award had the player played the slot game at a higher denomination by displaying the average expected payback percentage of the slot game and the total amount won during a designated per sod (such as any of those listed above) as well as what the average expected payback percentage of the slot game would have been and the total amount the player would have won had the player been playing the slot game at one or more higher denominations. For instance, the gaming system could display the following: “OVER THE PAST HOUR YOU WON $500 WITH AN AVERAGE EXPECTED PAYBACK PERCENTAGE OF 85%. HAD YOU PLAYED AT THE $1 DENOMINATION YOU WOULD HAVE WON $5,000 WITH A 92% AVERAGE EXPECTED PAYBACK PERCENTAGE!”

In other embodiments, the gaming system indicates that the player would have won a larger award had the player played the slot game at a higher denomination by displaying a missed award amount associated with a plurality of different wager amounts at one or more higher denominations. For example, if the player won m award of $10.00 on a $2.00 wager at the $0.01 denomination, the gaming system could display the following: “YOU WOULD HAVE WON $15.00 HAD YOU PLACED A $1,00 WAGER AT THE $1 DENOMINATION. $50 HAD YOU PLACED THE $2.00 WAGER AT THE $1 DENOMINATION, AND $100 HAD YOU PLACED A $4.00 WAGER-AT THE $1 DENOMINATION.” Put differently. In these embodiments, the gaming system indicates that the player would have woo a larger award had the player wagered more, less, and/or the same ate higher denomination.

In another embodiment instead of or in addition to displaying any of the above-described indications, the gaming system outputs one or more audio messages to aurally indicate to the player that the player would have won a larger award had the player played the slot game at a higher denomination.

In another embodiment, if the gaming system at which the player is playing the slot game is not a multi-denominational gaming system that enables the player to change the denomination at which the slot game is played, the gaming system displays or otherwise provides the player directions to a gaming system of a higher denomination in association with its indication that the player would have won a larger award had the player played the slot game at a higher denomination. For example, the gaming system provides the player with directions on the player's smart phone or tablet computing device.

In another embodiment, if the gaming system at which the player is playing the slot game is a multi-denominational gaming system that enables the player to change the denomination at which the slot game is played, the gaming system displays or otherwise provides an offer to the player to change denominations in association with its indication that the player would have won a larger award had the player played the slot game at a higher denomination.

It should be appreciated that the gaming system indicates that the player would have won a larger award had the player played the slot game at a higher denomination in addition to displaying any paytables associated with the slot game and in addition to enabling a player to selectively access any paytables associated with the slot game (such as via a help semen), it should also be appreciated that the denomination of a gaming system differs from the amount wagered on a play of a game operable by the gaming system. For instance, a player can wager the same amount (e.g., $1) on a play of a game at any of a plurality of different denominations.

It should further be appreciated that in certain embodiments, if the player is playing, the slot game at the highest available denomination offered by a gaming establishment (e.g., if the player is playing the slot game at the $5 denomination and the $5 denomination is the highest denomination offered by the gaming establishment for that slot game), the gaming system does not determine whether the player would have won a larger award had the player been playing the slot game at a higher denomination (because, in these embodiments, the gaming establishment does not offer a higher denomination).

In various embodiments, certain of which are described below, the gaming system indicates that the player would have won a larger award had the player played the slot game at a higher denomination in certain specific instances instead of whenever the gaming system determines that the player would have won a larger award had the player played the slot game at a higher denomination.

In one embodiment, the gaming system indicates that the player would have won a larger award had the player played the slot game at a higher denomination if the missed award is at least a designated amount greater than the award won by the player. In one example, the gaming system indicates that the player would have won a larger award had the player played the slot game at a higher denomination if the missed award is at least 50% greater than the award won by the player.

In another embodiment, the gaming system indicates that the player would have won a larger award had the player played the slot game at a higher denomination i the award won by the player is of at least a designated amount or is a designated type of award.

In another embodiment, the gaming system indicates that the player would have won a larger award had the player played the slot game at a higher denomination during play of a bonus game or a secondary game.

In another embodiment, the gaming system indicates that the player would have won a larger award had the player played the slot game at a higher denomination if a friend of the player is playing at that higher denomination and the player would have won a larger award had the player been playing at that higher denomination. For example, Player A is playing at the $0.01 denomination and Player B, who is a friend of Player A, is playing at the $1 denomination. In this embodiment the gaming system indicates if Player A would have won a larger award had Player A been playing at the $1 denomination (i.e., the denomination at which her friend Player B is playing).

While in the above-described example embodiments the gaming system indicates that the player would have won a larger award that the award provided to the player had the player played the slot game at a higher denomination. In other embodiments the gaming system indicates that the player would have won an award had the player played the slot game at a higher denomination. More specifically, as noted above. In certain embodiments the average expected payback percentage of a game is increased by adding winning symbol combinations (such as scatter pay winning symbol combinations) to the paytable. Thus, in certain embodiments the slot game at a higher denomination has a higher average expected payback percentage that the slot game at a lower denomination because the paytable. of the slot game has additional winning symbol combinations at the higher denomination. Thus, in these embodiments, if the displayed outcome tor the play of the slot game at the lower denomination includes a symbol combination that is not a winning symbol combination at the lower denomination but is a winning symbol combination at the higher denomination, the gaming system indicates that the player would have won a larger award (i.e., the award associated with the winning symbol combination at the higher denomination) had the player been playing the slot game at the higher denomination.

For instance, in one example embodiment, the paytable of the slot game at the $1 denomination includes a winning symbol combination including, three scattered Dollar Sign symbols, while the paytable of the slot game at the $0.01 denomination does not include this winning symbol combination, in this example embodiment, if the gaming system displays an outcome including three scattered Dollar Sign symbols for a play of the slot game at the $0.01 denomination and a $1.00 wager, the gaming system; displays an indication that the player would have won the award associated with the three scattered Dollar Sign symbols (for the same $100 wager) had the player beers playing the slot game at the $1 denomination.

In various embodiments, if the player is not a member of a gaming establishment's loyalty program or is a member of the gaming establishments loyalty program but has not identified herself as so, the gaming system indicates the amount of loyalty points, the gaming system would have accumulated for the player had the player been a member of the loyalty program and identified herself as so. In certain embodiments, the gaming system does so without indicating whether the player would have won a larger award had the player played the slot game at a higher denomination, and in other embodiments the gaming system does so while also indicating whether the player would have won a larger award had the player played the slot game at a higher denomination.

In various embodiments, the gaming system indicates what a player would have won had the player been logged into a remote host- or central controller-enabled system. For instance, in one example embodiment, the gaming system indicates any money, virtual currency, avatars, upgrades, achievements, and points that the player would have won had the player been logged into the remote host-enabled system. For example, when a player who is playing a video poker game and who did not log ante the remote host-enabled system achieves a royal flush, the gaming system indicates that the gaming system would have provided the player a customized avatar had the player been logged into the remote host-enabled system. In another example, the remote host- or central controller-enabled system awards a player points based on game play or other factors. The player can redeem the points for various items. In this example, if the player misses out on (by playing at too low a denomination) a $100.00 award that translates to 100 points, which are redeemable for a baseball cap or a buffet ticket at the casino, the gaming system indicates that the player could have won enough points to redeem for that baseball cap or buffet ticket had the player been logged into the remote host- or central controller-enabled system.

In certain embodiments, the gaming system indicates when the player would not have won a larger award had the player been playing at a higher denomination. In one such embodiment the gaming system indicates when the player would have won the same award had the player been playing at a higher denomination, and m another such embodiment, the gaming system indicates when the player would have won a smaller award had the player been playing at a higher denomination

It should be appreciated that:

(a) the quantity of reels;

(b) the quantity of symbol display areas;

(c) the symbols associated with the reels;

(d) the winning symbol combinations included in the paytable;

(e) the award associated with each winning symbol combination;

(f) the quantity of symbol display areas with which each reel is associated;

(g) the specific symbol display areas with which each reel is associated;

(h) the specific symbol display areas with which each payline is associated;

(i) the quantity of winning symbol combinations;

(j) the quantity and definition of paylines;

(k) the quantity of different denominations from which the player may select the player's desired denomination;

(l) the average expected payback percentages of the game for the different denominations;

(m) the type of indication the gaming system provides to indicate that the player would have won a larger award if the player had played the game at a higher denomination;

(n) when the gaming system indicates that, the player would have won a larger award had the player played the game at a higher denomination; and/or

(o) any other variables or determinations described herein

may be: (1) predetermined; (2) randomly determined; (3) randomly determined based on one or more weighted percentages; (4) determined based on a generated symbol or symbol combination; (5) determined independent of a generated symbol or symbol combination; (6) determined based on a random determination by a central controller (described below); (7) determined independent of a random determination by the central controller; (8) determined based on a random determination at an EGM configured to operate the slot game (described below); (9) determined independent of a random determination at the EGM; (10) determined based on at least one play of at least one game; (11) determined independent of at least one play of at least one game; (12) determined based on a player's selection; (13) determined independent of a player's selection; (14) determined based on one or more side wagers placed; (15) determined independent of one or more side wagers placed; (18) determined based on the player's primary game wager or wager level; (17) determined independent of the players primary game wager or wager level; (18) determined based on time (such as the time of day); (19) determined independent of time (such as. the time of day); (20) determined based on an amount of coin-in accumulated in one or more pools; (21) determined independent of an amount of coin-in accumulated in one or more pools; (22) determined based on a status of the player (i.e., a player tracking status); (23) .determined independent of a status of the player (i.e., a player tracking status); (24) determined based on one or more other determinations disclosed herein; (25) determined independent of any other determination disclosed herein; and/or (26) determined in any other suitable manner or based on or independent of any other suitable factor(s).

### Gaming Systems

It should be appreciated that the above-described embodiments of the present disclosure may be implemented in accordance with or in conjunction with one or more of a variety of different types of gaming systems, such as, but not limited to, those described below.

The present disclosure contemplates a variety of different gaming systems each having one or more of a plurality of different features, attributes, or characteristics. It should be appreciated that a “gaming system” as used herein refers to various configurations of: (a) one or more central servers, central controllers, or remote hosts; (b) one or more EGMs; and/or (c) one or more personal gaming devices, such as desktop computers, laptop computers, tablet computers or computing devices, personal digital assistants (PDAs), mobile telephones such as smart phones, and other mobile computing devices.

Thus, in various embodiments, the gaming, system of the present disclosure includes: (a) one or more EGMs in combination with one or more central servers, central controllers, or remote hosts; (b) one or more personal gaming devices in combination with one or more central servers, central controllers, or remote hosts; (c) one or more personal gaming devices in combination with one or more EGMs; (d) one or more personal gaming devices, one or more EGMs, and one or more central sewers, central controllers, or remote hosts in combination with one another; (e) a single EGM; (f) a plurality of EGMs in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity, each EGM and each personal gaming device of the present disclosure is collectively referred to herein as an “EGM.” Additionally, for brevity and clarity, unless specifically stated otherwise, “EGM” as used herein represents one EGM or a plurality of EGMs, and “central server, central controller or remote host” as used herein represents one central server, central controller, or remote host or a plurality of central servers, central controllers, or remote hosts.

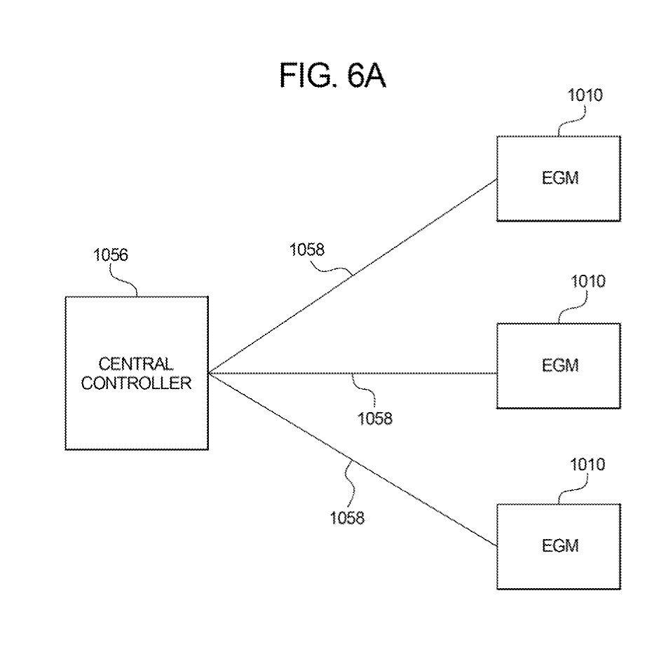

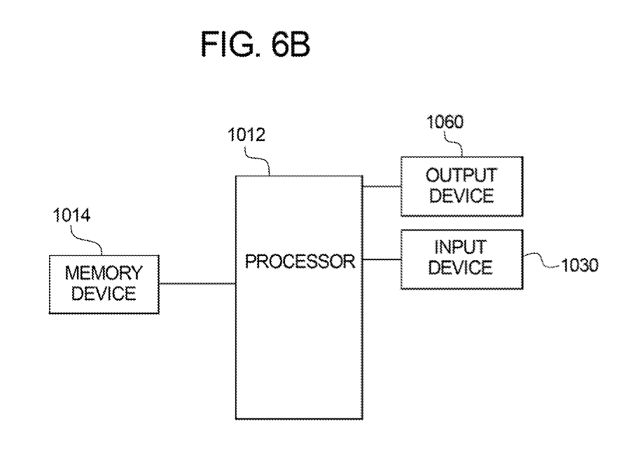

As noted above, in various embodiments, the gaming system includes an EGM in combination, with a central server, central controller, or remote host. In such embodiments, the EGM is configured to communicate with the central server, central controller; or remote host through a data network or remote communication link. In certain such embodiments, the EGM is configured to communicate with another EGM through the same data network or remote communication link or through a different data network or remote communication link. For example, the gaming system illustrated in FIG. 6A includes a plurality of EGMs 1010 that are each configured to communicate with a central server, central controller, or remote host 1056 through a data network 1058.

In certain embodiments in which the gaming system includes an EGM in combination with a central server, central controller, or remote host, the central server, central controller, or remote host is any suitable computing device (such as a server) that includes at least one processor and at least one memory device or storage device. As further described below, the EGM includes at least one EGM processor configured to transmit and receive data or signals representing events, messages, commands, or any other suitable information between the EGM and the central server, central controller, or remote host. The at least one processor of that EGM is configured to execute the events, messages, or commands represented by such data or signals in conjunction with the operation of the EGM. Moreover, the at least one processor of the central server, central controller, or remote host is configured to transmit and receive data or signals representing events, messages, commands, or any other suitable information between the central server, central controller, or remote host and the EGM. The at least one processor of the central server, central controller, or remote host is configured to execute the events, messages, or commands represented by such data or signals in conjunction with the operation of the central server, central controller, or remote host, ft should be appreciated that one, more, or each of the functions of the central server, central controller, or remote host may be performed by the at least one processor of the EGM. it should be further appreciated that one, more, or each of the functions of the at least one processor of the EGM may be performed by the at least one processor of the central server, central controller, or remote host.

In certain such embodiments, computerized instructions for controlling any games (such as any primary or base games and/or any secondary or bonus games) displayed by the EGM are executed by the central server, central controller, or remote host. In such “thin client” embodiments, the central server, central controller, or remote host remotely controls any games (or other suitable interfaces) displayed by the EGM, and the EGM is utilized to display such games (or suitable interfaces) and to receive one or more inputs or commands. In other such embodiments, computerized instructions for controlling any games displayed by the EGM are communicated from the central server, central controller, or remote host to the EGM and are stored in at least one memory device of the EGM. In such “thick client” embodiments, the at least one processor of the EGM executes the computerized instructions to control any games (or other suitable interfaces) displayed by the EGM.

In various embodiments in which the gaming system includes a plurality of EGMs, one or more of the EGMs are thin client EGMs and one or more of the EGMs are thick client EGMs. In other embodiments in which the gaming system includes one or more EGMs, certain functions of one or more of the EGMs. are implemented in a thin client environment and certain other functions of one or more of the EGMs are implemented in a thick client environment. In one such embodiment in which the gaming system includes an EGM and a central server, central controller, or remote host, computerized instructions for controlling any primary or base games displayed by the EGM are communicated from the central server, central controller, or remote host to the EGM in a thick client configuration, and computerized instructions tor controlling any secondary or bonus games or other functions displayed by the EGM are executed by the central server, central controller, or remote host in a thin client configuration.

In certain embodiments in which the gaming system includes; (a) an EGM configured to communicate with a central server, central controller, or remote host through a data network; and/or (b) a plurality of EGMs configured to communicate with one another through a data network, tie data network is a local area network (LAN) in which the EGMs are located substantially proximate to one another and/or the central server, central controller, or remote host. In one example, the EGMs and the central server, central controller, or remote host are located in a gaming establishment or a portion of a gaming establishment.

In other embodiments in which the gaming system includes; (a) an EGM configured to communicate with a central server, central controller, or remote host through a data network; and/or (b) a plurality of EGMs configured to communicate with one another through a data network, the data network is a wide area network (WAN) in which one or more of the EGMs are not necessarily located substantially proximate to another one of the EGMs and/or the central server, central controller, or remote host, For example, one or more of the EGMs are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs are located. It should be appreciated that in certain embodiments in which the data network is a WAN, the gaming system includes a central server; central controller, or remote host and an EGM each located in a different gaming establishment in a same geographic area, such as a same city or a same state. It should be appreciated that gaming systems in which the data network is a WAN are substantially identical to gaming systems in which the data network is a LAN, though the quantity of EGMs in such gaming systems may vary relative to one another.

In further embodiments in which the gaming system includes: (a) an EGM configured to communicate with a central server, central controller, or remote host through a data network; and/or (b) a plurality of EGMs configured to communicate with one another through a data network, the data network is an internet or an intranet. In certain such embodiments, an internet browser of the EGM is usable to access an internet game page tern any location where an internet connection is available. In one such embodiment, after the internet game page is accessed, the central server, central controller, or remote host identifies a player prior to enabling that player to place any wagers on any plays of any wagering games. In one example, the central server, central controller, or remote host identifies the player by requiring a player account of the player to be logged into via an input of a unique username and password combination assigned to the player. It should be appreciated, however, that the central server, central controller, or remote host may identify the player in any other suitable manner, such as by validating a player tracking identification number associated with the player; by reading a player tracking card or other smart card inserted into a card reader (as described below); by validating a unique player identification number associated with the player by the central server, central controller, or remote host; or by identifying the EGM, such as by identifying the MAC address or the IP address of the internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the internet browser of the EGM.

It should be appreciated that the central server, central controller, or remote host and the EGM are configured to connect to the data network or remote communications link in any syllable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile internet network), or any other suitable medium. It should be appreciated that the expansion in the quantity of computing devices and the quantity and speed of internet connections in recent years increases opportunities for players to use a variety of EGMs to play games from an ever-increasing quantity of remote sites. It should also be appreciated that the enhanced bandwidth of digital wireless communications may render such technology suitable for some or all communications, particularly if such communications are encrypted. Higher data transmission speeds may be useful for enhancing the sophistication and response of the display and interaction with players.

### EGM Components

In various embodiments, an EGM includes at least one processor configured to operate with at least one memory device, at least one input device, and at least one output device. The at least one processor may be any suitable processing device or set of processing devices, such as a microprocessor, a microcontroller-based platform, a suitable integrated circuit, or one or more application-specific integrated circuits (ASICs). FIG. 6B illustrates an example EGM including a processor 1012.

As generally noted above, the at least one processor of the EGM is configured to communicate with, configured to access, and configured to exchange signals with at least one memory device or data storage device. In various embodiments, the at least one memory device of the EGM includes random access memory (RAM), which can include non-volatile RAM (NVRAM), magnetic RAM (MRAM), ferroelectric RAM (FeRAM), and other forms as commonly understood in the gaming industry. In other embodiments, the at least one memory device includes read only memory (ROM). In certain embodiments, the at least one memory device of the EGM includes flash memory and/or EEPROM (electrically erasable programmable read only memory). The example EGM illustrated in FIG. 8B includes a memory device 1014. It should be appreciated that any other suitable magnetic, optical,, and/or semiconductor memory may operate in conjunction with the EGM disclosed herein. In certain embodiments, the at least one processor of the EGM and the at least one memory device of the EGM both reside within at cabinet of the EGM (as described below). In other embodiments, at least one of the at least one processor of the EGM and the at least one memory device of the EGM reside outside the cabinet of the EGM (as described below).

In certain embodiments, as generally described above, the at least one: memory device of the EGM stores program code and instructions executable by the at least one processor of the EGM to control the EGM. The at least one memory device of the EGM also stores other operating data, such as image data, event data, input data, random number generators (RNGs) or pseudo-RNGs, paytable data or information, and/or applicable game rules that relate to the play of one or more games on the EGM (such as primary or base games and/or secondary or bonus games as described below). In various embodiments, part or all of the program code and/or the operating data described above is stored in at least one detachable or removable memory device including, but not limited to, a cartridge, a disk, a CD ROM, a DVD, a USB memory device, or any other suitable non-transitory computer readable medium, in certain such embodiments, an operator (such as a gaming establishment operator) and/or a player uses such a removable memory device in an EGM to implement at least part of the present disclosure. In other embodiments, part or all of the program code and/or the operating data is downloaded to the at least one memory device of the EGM through any suitable data network described above (such as an internet or intranet).

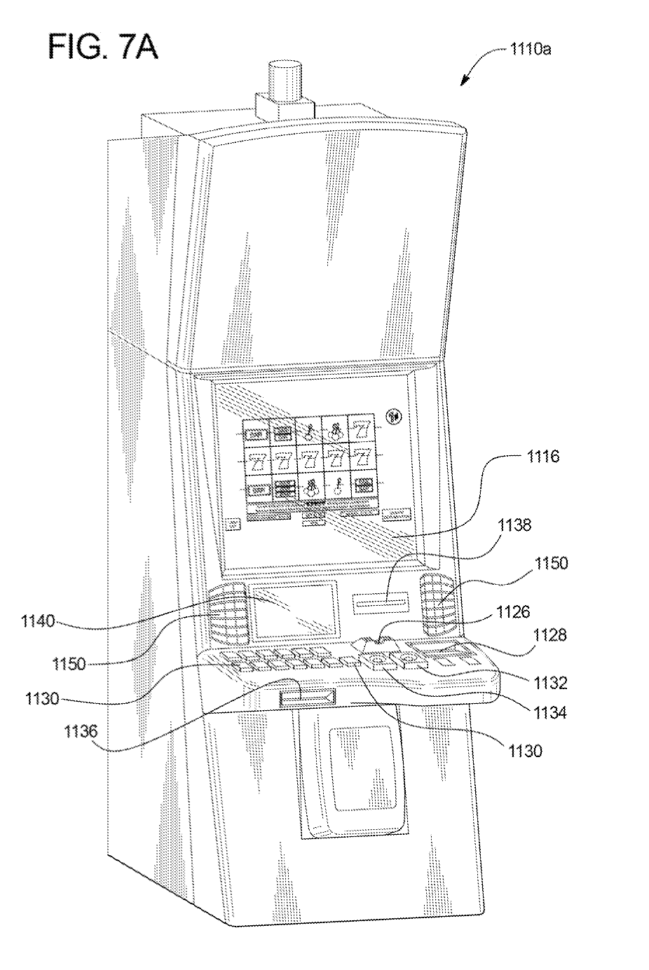

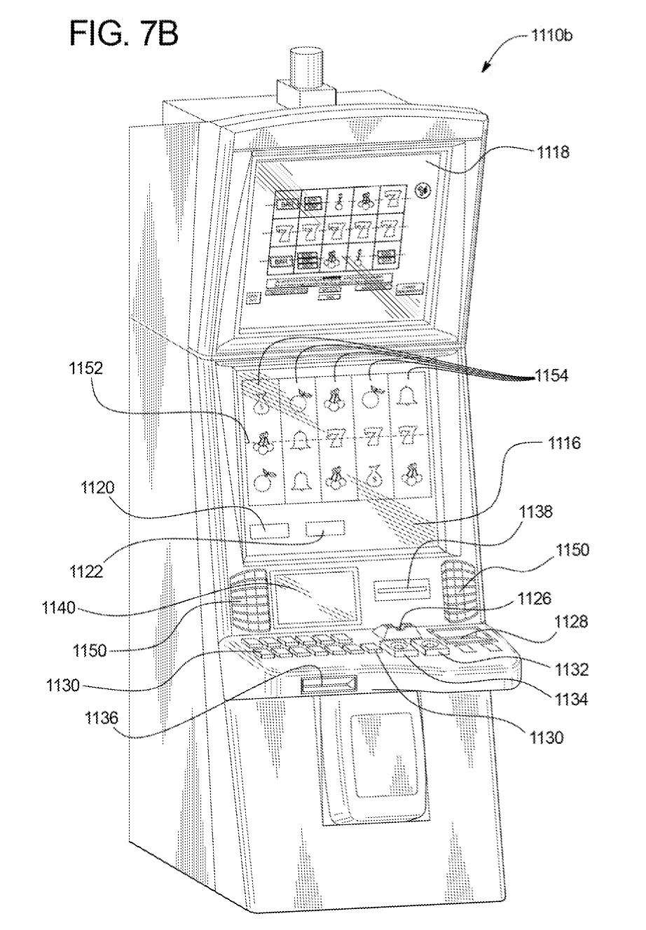

In various embodiments, the EGM includes one or more input devices. The input devices may include, any suitable device that, enables an input signal to be produced and received by the at least one processor of the EGM. The example EGM illustrated in FIG. 8B includes at least one input device 1030. One input device of the EGM is a payment device configured to communicate with the at least one processor of the EGM to fond the EGM. In certain embodiments, the payment device includes one or more of: (a) a bill acceptor into which paper money is inserted to fund the EGM; (b) a ticket acceptor into which a ticket or a voucher is inserted to fund the EGM; (c) a coin slot into which coins or tokens are inserted to fund the EGM; (d) a reader or a validator for credit cards, debit cards, or credit slips into which a credit card, debit card, or credit slip is inserted to fund the EGM; (e) a player identification card reader info which a player identification card is inserted to fund the EGM; or (f) any suitable combination thereof. FIGS. 7A and 7B illustrate example EGMs that each include fie following payment devices: (a) a combined bill and ticket acceptor 1128, and (b) a coin slot 1126.

In one embodiment, the EGM includes a payment device configured to enable the EGM to be funded via an electronic funds transfer, such as a transfer of funds from a bank account. In another embodiment, the EGM includes a payment device configured to communicate with a mobile device of a player, such as a cell phone, a radio frequency identification tag, or any other suitable, wired or wireless device, to retrieve relevant information associated with that player to fund the EGM, it should be appreciated that when the EGM is funded, the at least one processor determines the amount of funds entered and displays the corresponding amount on a credit display or any other suitable display as described below.

In various embodiments, one or more input devices of the EGM are one or more game play activation devices that are each used to initiate a play of a game on the EGM or a sequence of events associated with the EGM following appropriate funding of the EGM. The example EGMs illustrated in FIGS. 7A and 7B each include a game play activation device in the form of a game play initiation button 32. It should be appreciated that, in other embodiments, the EGM begins game play automatically upon appropriate funding rather than upon utilization of the game play activation device.

In certain embodiments, one or more input devices of the EGM are one or more wagering or betting devices. One such wagering or betting device is as a maximum wagering or betting device that, when utilized, causes a maximum wager to be placed. Another such wagering or betting device is a repeat the bet device that, when utilized, causes the previously-placed wager to be placed. A further such wagering or betting device is a bet one device. A bet is placed upon utilization of the bet one device. The bet is increased by one credit each time the bet one device is utilized. Upon the utilization of the bet one device, a quantity of credits shown in a credit display (as described below) decreases by one, and a number of credits shown in a bet display (as described below) increases by one.

In other embodiments, one input device of the EGM is a cash out device. The cash out device is utilized to receive a cash payment or any other suitable form of payment corresponding to a quantity of remaining credits of a credit display (as described below). The example EGMs illustrated in FIGS. 7A and 7B each include a cash out device in the form of a cash out button 1134.

In certain embodiments, one input device of the EGM is a touch-screen coupled to a touch-screen controller or other touch-sensitive display overlay to enable interaction with any images displayed on a display device (as described below). One such input device is s conventional touch-screen button panel. The touch-screen and the touch-screen controller are connected to a video controller. In these embodiments, signals are input to the EGM by touching the touch screen at the appropriate locations.

In various embodiments, one input device of the EGM is a sensor, such as a camera. In communication with the at least one processor of the EGM (and controlled by the at least one processor of the EGM in some embodiments) and configured to acquire an image or a video of a player using the EGM and/or an image or a video of an area surrounding the EGM.

In embodiments including a player tracking system, as further described below, one input device of the EGM is a card reader in communication with the at least one processor of the EGM. The example EGMs illustrated in FIGS. 7A and 7B each include a card reader 1138. The card reader is configured to read a player identification card inserted into the card reader.

In various embodiments, the EGM includes one or more output devices. The example EGM illustrated in FIG. 8B includes at least one output device 1080. One or more output devices of the EGM are one or more display devices configured to display any game(s) displayed by the EGM and any suitable information associated with such garnets). In certain embodiments, the display devices are connected to or mounted on a cabinet of the EGM (as described below). In various embodiments, the display devices serves as digital glass configured to advertise certain games or other aspects of the gaming establishment in which the EGM is located. In various embodiments, the EGM includes one or more of the following display devices: (a) a central display device; (b) a player tracking display configured to display various information regarding a player's player tracking status (as described below); (c) a secondary or upper display device in addition to the central display device and the player tracking display; (d) a credit display configured to display a current quantify of credits, amount of cash, account balance, or the equivalent; and (e) a bet display configured to display an amount wagered for one or more plays of one or more games. The example EGM illustrated in FIG. 7A includes a central display device 1116, a player tracking display 1140, a credit display 1120, and a bet display 1122. The example EGM illustrated in FIG. 7B includes a central display device 1118, an upper display device 1118, a player tracking display 1140, a player tracking display 1140, a credit display 1120, and a bet display 1122.

In various embodiments, the display devices include, without limitation: a monitor, a television display, a plasma display, a liquid crystal display (LCD), a display based on light emitting diodes (LEDs), a display based on a plurality of organic light-emitting diodes (OLEDs), a display based on polymer light-emitting diodes (PLEDs), a display based on a plurality of surface-conduction electron-emitters (SEDs) a display including a projected and/or reflected image, or any other suitable electronic device or display mechanism. In certain embodiments, as described above, the display device includes a touch-screen with an associated touch-screen controller. It should be appreciated that the display devices may be of any suitable sizes, shapes, and configurations.

The display devices of the EGM are configured to display one or more game and/or non-game images, symbols, and indicia. In certain embodiments, the display devices of the EGM are configured to display any suitable visual representation or exhibition of the movement of objects; dynamic lighting; video images; images of people, characters, places, things, and faces of cards; and the like. In certain embodiments, the display devices of the EGM are configured to display one or more video reels, one or more video wheels, and/or one or more video dice. In other embodiments, certain of the displayed images, symbols, and indicia are in mechanical form. That is, in these embodiments, the display device includes any electromechanical device, such as one or more rotatable wheels, one or more reels, and/or one or more dice, configured to display at least one or a plurality of game or other suitable images, symbols, or indicia.

In various embodiments, one output device of the EGM is a payout device. In these embodiments, when the cash out device is utilized as described above, the payout device causes a payout to be provided to the player. In one embodiment, the payout device is one or more of: (a) a ticket generator configured to generate: and provide a ticket or credit slip representing a payout, wherein the ticket or credit slip may be redeemed via a cashier, a kiosk, or other suitable redemption system; (b) a note generator configured to provide paper currency; (c) a coin generator configured to provide coins or tokens in a coin payout tray; and (d) any suitable combination thereof. The example EGMs illustrated in FIGS. 7A and 7B each include ticket generator 1136. In one embodiment, the EGM includes a payout device configured to fund an. electronically recordable identification card or smart card or a bank account via an electronic funds transfer.

In certain embodiments, one output device of the EGM is a sound generating device controlled by one or more sound cards. In one such embodiment the sound generating device includes one or more speakers or other sound generating hardware and/or software for generating sounds, such as by playing music for any games or by playing music for other modes of the EGM, such as an attract mode. The example EGMs illustrated in FIGS. 7A and 7B each include a plurality of speakers 1150. In another such embodiment, the EGM provides dynamic sounds coupled with attractive multimedia images displayed on one or more of the display devices to provide an audio-visual representation or to otherwise display full-motion video with sound to attract players to the EGM. In certain embodiments, the EGM displays a sequence of audio and/or visual attraction messages during idle periods to attract potential players to the EGM. The videos may be customized to provide any appropriate information.

In various embodiments, the EGM includes a plurality of communication ports configured to enable the at least one processor of the EGM to communicate with and to operate with external peripherals, such as: accelerometers, arcade sticks, bar code readers, bill validators, biometric input devices, bonus devices, button panels, card readers, coin dispensers, coin hoppers, display screens or other displays or video sources, expansion buses, information panels, keypads, lights, mass storage devices, microphones, motion sensors, motors, printers, reels, SCSI ports, solenoids, speakers, thumb-sticks, ticket readers, touch screens, trackballs, touchpads, wheels, and wireless communication devices. At least U.S. Patent Application Publication Mo. 2004/0254014 describes a variety of EGMs including one or more communication ports that enable the EGMs to communicate and operate with one or more external peripherals.

As generally described above, in certain embodiments, such as the example EGMs illustrated in FIGS. 7A and 7B, the EGM has a support structure, housing, or cabinet that provides support for a plurality of the input device and the output devices of the EGM. Further, the EGM is configured such that a player may operate ft while standing or sitting. In various embodiments, the EGM is positioned on a base or stand, or is configured as a pub-style tabletop game (not shown) that a player may operate typically while sitting. As illustrated by the different example EGMs shown in FIGS., 7A and 7B, EGMs may have varying cabinet and display configurations.

It should be appreciated that, in certain embodiments, the EGM is a device that has obtained approval from a regulatory gaming commission, and in other embodiments, the EGM is a device that has not obtained approval from a regulatory gaming commission.

As explained above, tor brevity and clarity, both the EGMs and the personal gaming devices of the present disclosure are collectively referred to herein as “EGMs.” Accordingly, it should be appreciated that certain of the example EGMs described above include certain elements that may hot be included in all EGMs. For example, the payment device of a personal gaming device such as a mobile telephone may not include a coin acceptor, while in certain instances the payment device of an EGM located in a gaming establishment may include a coin acceptor.

### Operation of Primary or Base Games and/or Secondary or Bonus Games

In various embodiments, an EGM may be implemented in one of a variety of different configurations. In various embodiments, the EGM may be implemented as one of: (a) a dedicated EGM wherein computerized game programs executable by the EGM for controlling any primary or base games (referred to herein as “primary games”) and/or any secondary or bonus games or other functions (referred to herein as “secondary games”) displayed by the EGM are provided with the EGM prior to delivery to a gaming establishment or prior to being provided to a player; and (b) a changeable EGM wherein computerized game programs executable by the EGM for controlling any primary games and/of secondary games displayed by the EGM are downloadable to the EGM through a data network or remote communication link after the EGM is physically located in a gaming establishment or after the EGM is provided to a player.

As generally explained above, in various embodiments in which the gaming system includes a central server, central controller, or remote host and a changeable EGM, the at least one memory device of the central server, central controller, or remote host stores different game programs and instructions executable by the at least one processor of the changeable EGM to control one or more primary games and/or secondary games displayed by the changeable EGM. More specifically, each such executable game program represents a different game or a different type of game that the at least one changeable EGM is configured to operate. In one example, certain of the game programs are executable by the changeable EGM to operate games having the same or substantially the same game play but different paytables. In different embodiments, each executable game program is associated with a primary game, a secondary game, or both. In certain embodiments, an executable game program is executable by the at least one processor of the at least one changeable EGM as a secondary game to be played simultaneously with a play of a primary game (which may be downloaded to or otherwise stored on the at least one changeable EGM), or vice versa.

In operation of such embodiments, the central server, central controller, or remote host is configured to communicate one or more of the stored executable game programs to the at least one processor of the changeable EGM. In different embodiments, a stored executable game program is communicated or delivered to the at least one processor of the changeable EGM by: (a) embedding the executable game program; in a device or a component (such as a microchip to be inserted into the changeable EGM); (b) writing the executable game program onto a disc or other media; or (c) uploading or streaming the executable game program over a data network (such as a dedicated data network). After the executable game program is communicated from the central server, central controller, or remote host to the changeable EGM, the at least one processor of the changeable EGM executes the executable game program to enable the primary game and/or the secondary game associated with that executable game program to be played using the display device(s) and/or the input device(s) of the changeable EGM. That is, when an executable game program is communicated to the at least one processor of the changeable EGM, the at least one processor of the changeable EGM changes the game or the type of game that may be played using the changeable EGM.

In certain embodiments, the gaming system randomly determines any game outcome(s) (such as a win outcome) and/or award(s) (such as a quantity of credits to award for the win outcome) for a play of a primary game and/or a play of a secondary game based on probability data. In certain such embodiments, this random determination is provided through utilization of an RNG, such as a true RNG or a pseudo RNG, or any other suitable randomization process. In one such embodiment, each game outcome or award is associated with a probability, and the gaming system generates the game outcome(s) and/or the award(s) to be provided based on the associated probabilities. In these embodiments, since the gaming system generates game outcomes and/or awards randomly or based on one or more probability calculations, there is no certainty that, the gaming system will ever provide any specific game outcome and/or award.

In certain embodiments, the gaming system maintains one or more predetermined pools or sets of predetermined game outcomes and/or awards. In certain such embodiments, upon generation or receipt of a game outcome and/or award request, the gaming system independently selects one of the predetermined game outcomes and/or awards, from the one or more pools or sets. The gaming system flags or marks the selected game outcome and/or award as used. Once a game outcome or an award is flagged as used, it is prevented from further selection from its respective pool or set; that is, the gaming system does not select that game outcome or award upon another game outcome and/or award request The gaming system provides the selected game outcome and/or award. At least U.S. Pat. Nos. 7,470,183; 7,563,183; and 7,833,092 and U.S. Patent Application Publication Nos. 2005/0148382, 2006/0094509, and 2003/0181743 describe various examples of this type of award determination.

In certain embodiments, the gaming system determines a predetermined game outcome and/or award based on the results of a bingo, keno, or lottery game, in certain such embodiments, the gaming system utilizes one or more bingo, keno, or lottery games to determine the predetermined game outcome and/or award provided for a primary game and/or a secondary game. The gaming system is provided or associated with a bingo card. Each bingo card consists of a matrix or array of elements, wherein each element is designated with separate indicia. After a bingo card is provided, the gaming system randomly selects or draws a plurality of the elements. As each element is selected, a determination is made as to whether the selected element is present on the bingo card, if the selected element is present on the bingo card, that selected element on the provided bingo card is marked or flagged. This process of selecting elements and marking any selected elements on the provided bingo cards continues until one or more predetermined patterns are marked on one or more of the provided bingo cards. After one or more predetermined patterns are marked on one or more of the provided bingo cards, game outcome and/or award is determined based, at least in part, on the selected elements on the provided bingo cards. At least U.S. Pat. Nos. 7,753,774; 7,731,581; 7,955,170; and 8,070,579 and U.S. Patent Application Publication No. 2011/0028201 describe various examples, of this type of award determination.

In certain embodiments in which the gaming system includes a central server, central controller, or remote host and an EGM, the EGM is configured to communicate with the central server, central controller, or remote host for monitoring purposes only. In such embodiments, the EGM determines the game outcome(s) and/or award(s) to be provided in any of the manners described above, and the central server, central controller, or remote host monitors the activities and events occurring on the EGM. In one such embodiment, the gaming system includes a real-time or online accounting and gaming information system configured to communicate with the central server, central controller, or remote host, in this embodiment, the accounting and gaming information system includes: (a) a player database for storing player profiles, (b) a player tracking module for tracking players (as described below), and (c) a credit system for providing automated transactions. At least U.S. Pat. No. 6,913,534 and U.S. Patent Application Publication No 2006/0281541 describe various examples of such accounting systems.

As noted above, in various embodiments, the gaming system includes one or more executable game programs executable by at least one processor of the gaming system to provide one or more primary games and one or more secondary games. The primary game(s) and the secondary game(s) may comprise any suitable games and/or wagering games, such as, but not limited to: electro-mechanical or video slot or spinning reel type games; video card games such as video draw poker, multi-hand video draw poker, other video poker games, video blackjack games, and video baccarat games; video keno games; video bingo games; and video selection games.

In certain embodiments in which the primary game is a slot or spinning reef type game, the gaming system includes one or more reels in either an electromechanical form with mechanical rotating reels or in a video form with simulated reels and movement thereof. Each reel displays a plurality of indicia or symbols, such as belts, hearts, fruits, numbers, letters, bars, or other images that typically correspond to a theme associated with the gaming system. In certain such embodiments, the gaming system: includes one or more paylines associated with the reels. The example EGM shown in FIG. 7B includes a payline 1152 and a plurality of reels 1154. In certain embodiments, one or more of the reels are independent reels or unisymbol reels. In such embodiments, each independent reel generates and displays one symbol.

In various embodiments, one or more of the paylines is horizontal, vertical, circular, diagonal, angled, or any suitable combination thereof. In other embodiments, each of one or more of the paylines is associated with a plurality of adjacent symbol display areas on a requisite number of adjacent reels. In one such embodiment, one or more paylines are formed between at least two symbol display areas that are adjacent to each other by either sharing a common side of sharing a common corner (i.e., such paylines are connected paylines). The gaming system enables a wager to be placed on one or more of such paylines to activate such paylines. In other embodiments in which one or more paylines are formed between at least two adjacent symbol display areas, the gaming system enables a wager to be placed on a plurality of symbol display areas, which activates those symbol display areas.

In various embodiments, the gaming system provides one or more awards after a spin of the reels when specified-types and/or configurations of the indicia or symbols on the reels occur on an active payline or otherwise occur in a winning pattern, occur on the requisite number of adjacent reels, and/or occur in a scatter pay arrangement.

In certain embodiments, the gaming system employs a ways to win award determination. In these embodiments, any outcome to be provided is determined based on a number of associated symbols that are generated in active symbol display areas on the requisite number of adjacent reels (i.e., not on paylines passing through any displayed winning symbol combinations). If a winning symbol combination is generated on the reels, one award for that occurrence of the generated winning symbol combination is provided. At least U.S. Pat. No. 3,012,011 and U.S. Patent Application Publication Nos. 2000/0108408 and 2008/0132320 describe various examples of ways to win award determinations.

In various embodiments, the gaming system includes a progressive award. Typically, a progressive award includes an initial amount and an additional amount funded through a portion of each wager placed to initiate a play of a primary game. When one or mom triggering events occurs, the gaming system provides at least a portion of the progressive award. After the gaming system provides the progressive award, an amount of the progressive award is reset to the initial amount and a portion of each subsequent wager is allocated to the next progressive award. At least U.S. Pat. Nos. 5,766,079; 7,585,223; 7,661,392; 7,668,093; 7,180,523; and 7,905,778 and U.S. Patent Application Publication Nos. 2008/0020848, 2009/0123364, 2009/0123383, and 2010/0227877 describe venous examples of different progressive gaming systems.

As generally noted above, in addition to providing winning credits or other awards for one or more plays of the primary game(s), in various embodiments the gaming system provides credits or other awards for one or more plays of one or more secondary games. The secondary game typically enables an award to be obtained addition to any award obtained through play of the primary game(s). The secondary game(s) typically produces a higher level of player excitement than the primary game(s) because the secondary gamers) provides a greater expectation of winning than the primary game(s) and is accompanied with more attractive or unusual features than the primary game(s). It should be appreciated that the secondary game(s) may be any type of suitable game, either similar to or completely different from the primary game.

In various embodiments, the gaming system automatically provides or initiates the secondary game upon the occurrence of a triggering event or the satisfaction of a qualifying condition. In other embodiments, the gaming system initiates the secondary game upon the occurrence of the triggering event or the satisfaction of the qualifying condition and upon receipt of an initiation input. In certain embodiments, the triggering event or qualifying condition is a selected outcome in the primary game(s) or a particular arrangement of one or more indicia on a display device for a play of the primary game(s), such as a “BONUS” symbol appearing on three adjacent reels along a payline following a spin of the reels for a play of the primary game. In other embodiments, the triggering event or qualifying condition occurs based on a certain amount of game play (such as number of games, number of credits, amount of time) being exceeded, or based on a specified number of points being earned during game play. It should be appreciated that any suitable triggering event or qualifying condition or any suitable combination of a plurality of different triggering events or qualifying conditions may be employed.

In other embodiments, at least one processor of the gaming system randomly determines when to provide one or more plays of one or more secondary games. In one such embodiment, no apparent reason is provided for the providing of the secondary game. In this embodiment, qualifying for a secondary game is not triggered by the occurrence of an event in any primary game or based specifically on any of the plays of any primary game. That is, qualification is provided without any explanation or, alternatively, with a simple explanation. In another such embodiment, the gaming system determines qualification for a secondary game at least partially based on a game triggered or symbol triggered event, such as at least partially based on play of a primary game.

In various embodiments, after qualification for a secondary game has been determined, the secondary game participation may be enhanced through continued play on the primary game. Thus, in certain embodiments, for each secondary game qualifying event, such as a secondary game symbol, that is obtained, a given number of secondary game wagering points or credits is accumulated in a “secondary game meter” configured to accrue the secondary game wagering credits or entries toward eventual participation in the secondary game. In one such embodiment, the occurrence of multiple such secondary game qualifying events in the primary game results in an arithmetic or exponential increase in the number of secondary game wagering credits awarded. In another such embodiment, any extra secondary game wagering credits may be redeemed during the secondary game to extend play of the secondary game.

In certain embodiments, no separate entry fee or buy-in for the secondary game is required. That is, entry into the secondary game cannot be purchased; rather, in these embodiments entry must be won or earned through play of the primary game, thereby encouraging play of the primary game. In other embodiments, qualification for the secondary game is accomplished through a simple “buy-in.” For example, qualification through other specified activities is unsuccessful, payment of a fee or placement of an additional wager “buys-in” to the secondary game In certain embodiments, a separate side wager must be placed on the secondary game or a wager of a designated amount must be placed on the primary game to enable qualification for the secondary game. In these embodiments, the secondary game triggering event must occur and the side wager (or designated primary game wager amount) must have been placed for the secondary game to trigger.

In various embodiments in which the gaming system includes a plurality of EGMs, the EGMs are configured to communicate with one another to provide a group gaming environment in certain such embodiments, the EGMs enable players of those EGMs to work in conjunction with one another, such as by enabling the players to play together as a team or group, to win one or more awards. In other such embodiments, the EGMs enable players of those EGMs to compete against one another for one or more awards. In one such embodiment the EGMs enable the players of those EGMs to participate in one or more gaming tournaments for one or more awards. At least U.S. Patent Application Publication Nos. 2007/0123341, 2008/0070680, 2008/0176650, and 2008/0124363 describe various examples of different group gaming systems.

In various embodiments, the gaming system includes one or more player tracking systems. Such player tracking systems enable operators of the gaming system (such as casinos or other gaming establishments) to recognize the value of customer loyalty by identifying frequent customers and rewarding them for their patronage. Such a player tracking system is configured to tack a player's gaming activity. In one such embodiment, the player tracking system does so through the use of player tracking cards. In this embodiment, a player is issued a player identification card that has an encoded player identification number that uniquely identifies the player. When the player's playing tracking card is inserted into a card reader of the gaming system to begin a gaming session, the card reader reads the player identification number off the player tracking card to identify the player. The gaming system timely tracks any suitable information or data relating to the identified player's gaming session. The gaming system also timely tracks when the player tracking card is removed to conclude play for that gaming session. In another embodiment, rather than requiring insertion of a player tracking card into the card reader, the gaming system utilizes one or more portable devices, such as a cell phone, a radio frequency identification tag, or any other suitable wireless device, to track when a gaming session begins and ends. In another embodiment, the gaming system utilizes any suitable biometric technology or ticket technology to track when a gaming session begins and ends.

In such embodiments, during one or more gaming sessions, the gaming system tracks any suitable information or data, such as any amounts wagered, average wager amounts, and/or the time at which these wagers are placed in different embodiments, for one or more players, the player tracking system includes the player's account number, the player's card number, the player's first name, the players surname, the player's preferred name, the player's player tracking ranking, any promotion status associated with the player's player tracking card, the player's address, the player's birthday, the player's anniversary, the player's recent gaming sessions, or any other suitable data, in various embodiments, such tracked information and/or any suitable feature associated with the player tracking system is displayed on a player tracing display. In various embodiments, such tracked information and/or any suitable feature associated with the player tracking system is displayed via one or more service windows that are displayed on the central display device and/or the upper display device. At least U.S. Pat. Nos. 6,722,985; 8,908,387; 7,311,805; 7,611,411; 7,817,151; and 8,057,298 describe various examples of player tracking systems,

It should be understood that various changes and modifications to the present embodiments described herein will be apparent to those skilled in the art Such changes and modifications can be made without departing from the spirit and scope of the present subject matter and without diminishing its intended advantages. It is therefore intended that such changes and modifications be covered by the appended claims.

The invention is claimed as follows:

1. A gaming system comprising:
at least one input device;
at least one display device;
at least one processor; and
at least one memory device that stores a plurality of instructions which, when executed by the at least one processor, cause the at least one processor to operate with the at least one input device and the at least one display device to:
(a) receive, from a player, a wager on a play of a game at a first denomination;
(b) determine an outcome of the wagered-on play of the game at the first denomination;
(c) display the determined outcome of the wagered-on play of the game at the first denomination;
(d) determine an award amount associated with the displayed outcome of the wagered-on play of the game at the first denomination;
(e) display the determined award amount associated with the displayed outcome of the wagered-on play of the game at the first denomination,
(f) determine, based on the displayed outcome of the wagered-on play of the game at the first denomination, whether a higher award amount would have been determined had the game been played at a second higher denomination; and
(g) if a higher award amount would have been determined had the game been played at the second higher denomination, display an indication that a higher award amount would have been won had the game been played at the second higher denomination.

2. The gaming system of claim 1, wherein the plurality of instructions, when executed by the at least one processor, cause the at least one processor to determine, based on the displayed outcome of the wagered-on play of the game at the first denomination, a missed award amount that would have been determined had the game been played at the second higher denomination.

3. The gaming system of claim 2, wherein the displayed indication that a higher award amount would have been won had the game been played at the second higher denomination includes the missed award amount.

4. The gaming system of claim 1, wherein the plurality of instructions, when executed by the at least one processor, cause the at least one processor to operate with the at least one display device to display; (i) a total award amount won by the player over a designated period, and (ii) a total award amount that would have been won by the player over the designated period had the player been playing at the second higher denomination.

5. The gaming system of claim 1, wherein the plurality of instructions, when executed by the at least one processor, cause the at least one processor to operate with the at least one display device to:
(i) determine, based on the displayed outcome of the wagered-on play of the game at the first denomination, whether a higher award amount would have been determined had the game been played at. a third higher denomination, and
(ii) if a higher award amount would have been determined had the game been played at the third higher denomination, display an indication that a higher award amount would have been won had the game been played at the third higher denomination.

6. The gaming system of claim 1, wherein the plurality of instructions, when executed by the at least one processor, cause the at least one processor to, if the gaming system has not identified a player tracking account of the player, operate with the at least one display device to display an indication including a quantity of player tracking points the player would nave-accumulated in association with said play of the game had the player tracking account of the player been identified.

7. A method of operating a gaming system, said method comprising:
(a) causing at least one processor to execute a plurality of instructions stored in at least one memory device to operate with at least one input device to receive, from a player, a wager on a play of a game at a first denomination;
(b) causing the at least one processor to execute the plurality of instructions to determine an outcome of the wagered-on play of the game at the first denomination;
(c) causing the at least one processor to execute the plurality of instructions to operate with at least one display device to display the determined outcome of the wagered-on play of the game at the first denomination;
(d) causing the at least one processor to execute the plurality of instructions to determine an award amount associated with the displayed outcome of the wagered-on play of the game at the first denomination;
(e) causing the at least, one processor to execute the plurality of instructions to operate with the at least one display device to display the determined award amount associated with the displayed outcome of the wagered-on play of the game at the first denomination;
(f) causing the at least one processor to execute the plurality of instructions to determine, based on the displayed outcome of the wagered-on play of the game at the first denomination, whether a higher award amount would have been determined had the game been played at a second higher denomination; and
(g) if a higher award amount would have been determined had the game been played at the second higher denomination, causing the at least one processor to execute the plurality of instructions to operate with the at least one display device to display an indication that a higher award amount would have been won had the game been played at the second higher denomination.

8. The method of claim 7, which includes causing the at least one processor to execute the plurality of instructions to determine, based on the displayed outcome of the wagered-on play of the game at the first denomination, a missed award amount that would have been determined had the game been played at the second higher denomination.

9. The method of claim 8, wherein the displayed indication that a higher award amount would have been woo had the game been played at the second higher denomination deludes the missed award amount.

10. The method of claim 7, which includes causing the at least one processor to execute the plurality of instructions to operate with the at least one display device to display: (i) a total award amount won by the player over a designated period, and (ii) a total award amount that would have been won by the player over the designated period had the player been playing at the second higher denomination.

11. The method of claim 7, which includes causing the at least one processor to execute the plurality of instructions to operate with the at least one display device to:
(i) determine, based on the displayed outcome of the wagered-on play of the game at the first denomination, whether a higher award amount would have been determined had the game been played at a third higher denomination; and
(ii) if a higher award amount would have been determined, had the game been played at the third higher denomination, display an indication that a higher award amount would have been won had the game been played at the third higher denomination.

12. The method of claim 7, which includes causing the at least one processor to execute: the plurality of instructions to, if the gaming system has not identified a player tracking account of the player, operate with the at least one display device to display an indication including a quantity of player tracking points the player would have accumulated in association with said play of the game had the player tracking account of the player been identified.

13. The method of claim 7, which is provided through a data network.

14. The method of claim 13, wherein tie data network is an internet.

15. A non-transitory computer readable medium storing a plurality of instructions which, when executed by at least one processor, cause the at least one processor to:
(a) operate with at least one input device to receive, from a player, a wager on a play of a game at a first denomination;
(b) determine an outcome of the wagered-on play of the game at the first denomination;
(c) cause at least one display device to display the determined outcome of the wagered-on play of the game at the first denomination;
(d) determine an award amount associated with the displayed outcome of the wagered-on play of the game at the first denomination;
(e) cause the at least one display device to display the determined award amount associated with the displayed outcome of the wagered-on play of the game at the first denomination;
(f) determine, based on the displayed outcome of the wagered-on play of the game at the first denomination, whether a higher award amount would have been determined had the game been played at a second higher denomination; and
(g) if a higher award amount would have been determined had the game been played at the second higher denomination, cause the at least one display device to display an indication that a higher award amount would have been won had the game been played at the second higher denomination.

16. The non-transitory computer readable medium of claim 15, wherein the plurality of instructions, when executed by the at least one processor, cause the at least one processor to determine, based on the displayed outcome of the wagered-on play of the game at the first denomination, a missed award amount that would have been determined had the game been played at the second higher denomination.

17. The non-transitory computer readable medium of claim 18, wherein the displayed indication that a higher award amount, would have been won had the game been played at the second higher denomination includes the missed award amount.

18. The non-transitory computer readable medium of claim 16, wherein the plurality of instructions, when executed by the at least one processor, cause the at least one processor to: cause the at least one display device to display: (i) a total award amount won by the player over a designated period, and (ii) a total award amount that would have been won by the player over the designated period had the player been playing at the second higher denomination.

19. The non-transitory computer readable medium of claim 15, wherein the plurality of instructions, when executed by the at least one processor, cause the at least one processor to:
(i) determine, based on the displayed outcome of the wagered-on play of the game at the first denomination, whether a higher award amount would have been determined had the game been played at a third higher denomination; and
(ii) if a higher award amount would have been determined had the game been played at the third higher denomination, cause the at least one display device to display an indication that a higher award amount would have been won had the game been played at the third higher denomination.

20. The non-transitory computer readable medium of claim 15, wherein the plurality of instructions, when executed by the at least one processor, cause the at least one processor to, if the gaming system has not identified a player tracking account of the player, cause the at least one display device to display an indication including a quantity of player tracking points the player would have accumulated in association with said play of the game had the player tracking account of the player been identified.
